(19) United States
(12) Patent Application Publication
(10) Pub. No.: US 2016/0128012 A1
(43) Pub. Date: May 5, 2016

(54) COMMUNICATION SYSTEM, COMMUNICATION SYSTEM CONTROL METHOD, TRANSMISSION DEVICE, AND RECEPTION DEVICE

(71) Applicant: NEC Corporation, Tokyo (JP)

(72) Inventor: Kazuki Shibata, Tokyo (JP)

(21) Appl. No.: 14/899,001

(22) PCT Filed: Jun. 4, 2014
(86) PCT No.: PCT/JP2014/002967

§ 371 Date: Dec. 16, 2015

(30) Foreign Application Priority Data
Jun. 18, 2013 (JP) 2013-127406

(51) Int. Cl. H04W 56/00; H04L 7/00

(52) U.S. Cl. CPC H04W 56/0015; H04L 7/0012

(57) ABSTRACT

A counter (11) is synchronized with a counter (25) within a communication device (2), and measures, as a first count value, a timing before a PTP packet is input to a processing unit (13) that performs processing on the PTP packet. A subtraction unit (12) subtracts the first count value from a correction field within the PTP packet. The counter (25) measures, as a second counter, a timing when processing by a processing unit (23) that performs processing on the PTP packet is completed. A modification unit (24) modifies a correction field based on the second count value and a value of the correction field. Thus, the present invention provides a communication device, a communication method, and a communication system which are capable of modifying a delay amount field with a simple configuration.

### TECHNICAL FIELD

The present invention relates to a communication system, a communication system control method, a transmission device, and a reception device. In particular, the present invention relates to a communication system, a communication system control method, a transmission device, and a reception device which perform time synchronization between communication devices.

### BACKGROUND ART

In recent years, a technique for performing time synchronization between communication devices has attracted attention. An example of a technical specification for this time synchronization technique is IEEE (Institute of Electrical and Electronic Engineers) 1588. The IEEE 1588 defines PTP (Precision Time Protocol). This PTP is a protocol for accurate time synchronization between communication devices within a network.

An outline of a time synchronization process using the PTP will be described below. In the time synchronization, a propagation delay time between a master node and a slave node is measured and time information within each device is corrected based on the propagation delay time, thereby achieving accurate time synchronization.

First, the master node transmits a Sync message. At this time, the master node holds a time t1 when the Sync message is transmitted. The slave node holds a time t2 when the Sync message is received. The master node inserts information about the time t1 into a Follow_Up message, and transmits the Follow_Up message. The slave node receives the Follow_Up message to thereby obtain the information about the time t1. Subsequently, the slave node transmits a Delay_Req message at a time t3. The master node inserts, into a Delay_Resp message, information about a time t4 when the Delay_Req message is received, and transmits the Delay_Resp message to the slave node. The slave node receives the Delay_Resp message to thereby recognize the times t1 to t4. A propagation delay time can be calculated by the formula ((t2−t1)+(t4−t3))/2. The slave node corrects the time of the slave node using the propagation delay time, thereby performing time synchronization between the slave node and the master node.

In this case, relay devices are generally present on a path between the master node and a client node. Each relay device measures a processing delay time within the relay device, and sets the processing delay time in a correction field within each synchronization message (e.g., Follow_Up message). The term “correction field” refers to a field (delay amount field) in which a total time during which the synchronization message remains in nodes (e.g., relay devices) other than the master node and the slave node (i.e., a total delay time in all devices except the master node and the slave node) is set.

In general, each relay device modifies the correction field (delay amount field) every time processing in an internal processing unit in which a delay occurs is completed.

Patent Literature 1 discloses a technique for establishing timing synchronization between communication devices with a simple configuration. Patent Literature 2 discloses a communication system capable of transmitting image data while securing frame synchronization using a digital interface. However, Patent Literature 1 and Patent Literature 2 fail to disclose a configuration of a field corresponding to the above-mentioned correction field.

### CITATION LIST

### Patent Literature

[Patent Literature 1] Japanese Unexamined Patent Application Publication No. 2010-233108
[Patent Literature 2] Japanese Unexamined Patent Application Publication No. 2006-245942

### SUMMARY OF INVENTION

### Technical Problem

As described above, a general relay device modifies the delay amount field every time processing in an internal processing unit is completed. However, when a plurality of internal processing units in which a delay occurs are present in a relay device, it is necessary to provide a configuration for modifying the delay amount field every time processing in the internal processing units is completed. That is, there is a problem that the internal configuration of each relay device is complicated.

The present invention has been made in view of the above-mentioned problem, and a principal object of the present invention is to provide a communication system, a communication system control method, a transmission device, and a reception device which are capable of modifying a delay amount field with a simple configuration.

### Solution to Problem

An exemplary aspect of a communication system according to the present invention is a communication system including: a transmission device that transmits a time synchronization packet for time synchronization; and a reception device that receives the time synchronization packet. The transmission device includes: a first counter that is synchronized with a second counter within the reception device, and measures, as a first count value, a timing before the time synchronization packet is input to a processing unit that performs processing on the time synchronization packet; and a subtraction unit that modifies a value of a delay amount field within the time synchronization packet with a value obtained by subtracting the first count value, the value of the delay amount field indicating a total amount of delay in a relay device. The reception device includes: the second counter that measures, as a second count value, a timing when processing by a processing unit that performs processing on the time synchronization packet is completed; and a modification unit that modifies the delay amount field based on the second count value and the value of the delay amount field.

An exemplary aspect of a communication system control method according to the present invention is a control method for a communication system including: a transmission device that transmits a time synchronization packet for time synchronization; and a reception device that receives the time synchronization packet, the control method including: a first counting step of establishing, by the transmission device, synchronization with a counter within the reception device and measuring, as a first count value, a timing before the time synchronization packet is input to a processing unit that performs processing on the time synchronization packet; a subtraction step of modifying, by the transmission device, a value of a delay amount field within the time synchronization packet with a value obtained by subtracting the first count value, the value of the delay amount field indicating a total amount of delay in a relay device; a second counting step of measuring, by the reception device, a timing when processing by a processing unit that performs processing on the time synchronization packet is completed, as a second count value; and a modification step of modifying, by the reception device, the delay amount field based on the second count value and the value of the delay amount field.

An exemplary aspect of a transmission device according to the present invention is a transmission device that transmits a time synchronization packet for time synchronization, the transmission device including: a first counter that measures, as a first count value, a timing before the time synchronization packet is input to a processing unit that performs processing on the time synchronization packet; and a subtraction unit that modifies a value of a delay amount field within the time synchronization packet with a value obtained by subtracting the first count value, the value of the delay amount field indicating a total amount of delay in a relay device.

An exemplary aspect of a reception device according to the present invention is a reception device that receives a time synchronization packet for time synchronization, the reception device including: the second counter that measures, as a second count value, a timing when processing by a processing unit that performs processing on the time synchronization packet is completed; and a modification unit that modifies a delay amount field based on the second count value and a value of the delay amount field.

### Advantageous Effects of Invention

According to the present invention, it is possible to provide a communication system, a communication system control method, a transmission device, and a reception device which are capable of modifying a delay amount field with a simple configuration.

### BRIEF DESCRIPTION OF DRAWINGS

FIG. 1 is a block diagram showing a configuration of a communication system 100 according to a first exemplary embodiment;

FIG. 2 is a diagram showing the concept of packet synchronization according to the first exemplary embodiment;

FIG. 3 a conceptual diagram showing correction field values and a relationship between count values of counters 11 and 25 according to the first exemplary embodiment;

FIG. 4 is a conceptual diagram showing a counting operation of the counter 11 according to the first exemplary embodiment;

FIG. 5 is a conceptual diagram showing a count value adjustment of the counter 11 (or the counter 25) according to the first exemplary embodiment;

FIG. 6 is a conceptual diagram showing a count value adjustment of the counter 11 (or the counter 25) according to a third exemplary embodiment;

FIG. 7 is a block diagram showing a configuration of the communication system 100 according to a fourth exemplary embodiment.

### DESCRIPTION OF EMBODIMENTS

### First Exemplary Embodiment

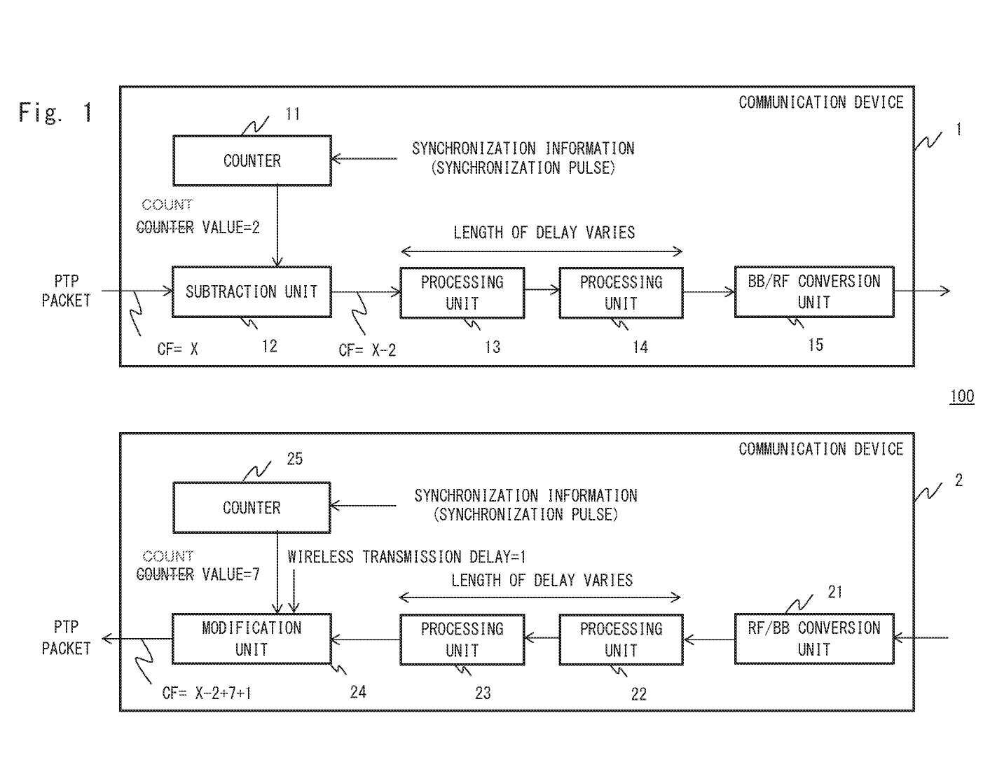

Exemplary embodiments of the present invention will be described below with reference to the drawings. FIG. 1 is a block diagram showing a configuration of a communication system 100 according to this exemplary embodiment. The communication system 100 includes a communication device 1 and a communication device 2. The communication device 1 and the communication device 2 are devices each having a function of performing transmission and reception processes on various data. For example, the communication device 1 and the communication device 2 are wireless communication devices that connect cellular phone base stations to each other. The communication device 1 and the communication device 2 are not limited to wireless communication devices that connect base stations to each other. Devices that perform wired communication may also be used as the communication devices 1 and 2 as long as they can relay a time synchronization packet. In the following description, assume that the time synchronization packet is a PTP (Precision Time Protocol) packet that conforms to the IEEE 1588 and that the communication device 1 and the communication device 2 perform wireless communication. The operation and configuration of the communication devices 1 and 2 in which the communication devices transmit the PTP packet by wireless communication will be mainly described below. However, the communication device 1 and the communication device 2 can also transmit and receive any other packets and the like as needed.

The communication device 1 includes a counter 11, a subtraction unit 12, a processing unit 13, a processing unit 14, and a BB (Base Band)/RF (Radio Frequency) conversion unit 15. The communication device 2 includes an RF/BB conversion unit 21, a processing unit 22, a processing unit 23, a modification unit 24, and a counter 25. The communication device 1 is a transmission device that transmits the PTP packet, and the communication device 2 is a reception device that receives the PTP packet. Specifically, the communication device 1 receives the PTP packet from another communication device, and transmits the PTP packet so as to relay the PTP packet. Operations of each processing unit in the communication device 1 will now be described.

The counter 11 is a general counter that counts the time. A maximum count value of the counter 11 is set to be sufficiently larger than a delay amount or a communication delay within the communication device 1. When the count value reaches the maximum count value, the counter 11 resets the count value to “0” and continues counting. The counter 25, which is described later, may have a maximum count value that is different from that of the counter 11, as long as the counter 25 is synchronized with the counter 11. However, it is desirable that the maximum count value of the counter 25 be equal to the maximum count value of the counter 11. This contributes to the establishment of more accurate synchronization. In the following description, assume that the maximum count value of the counter 11 is equal to the maximum count value of the counter 25.

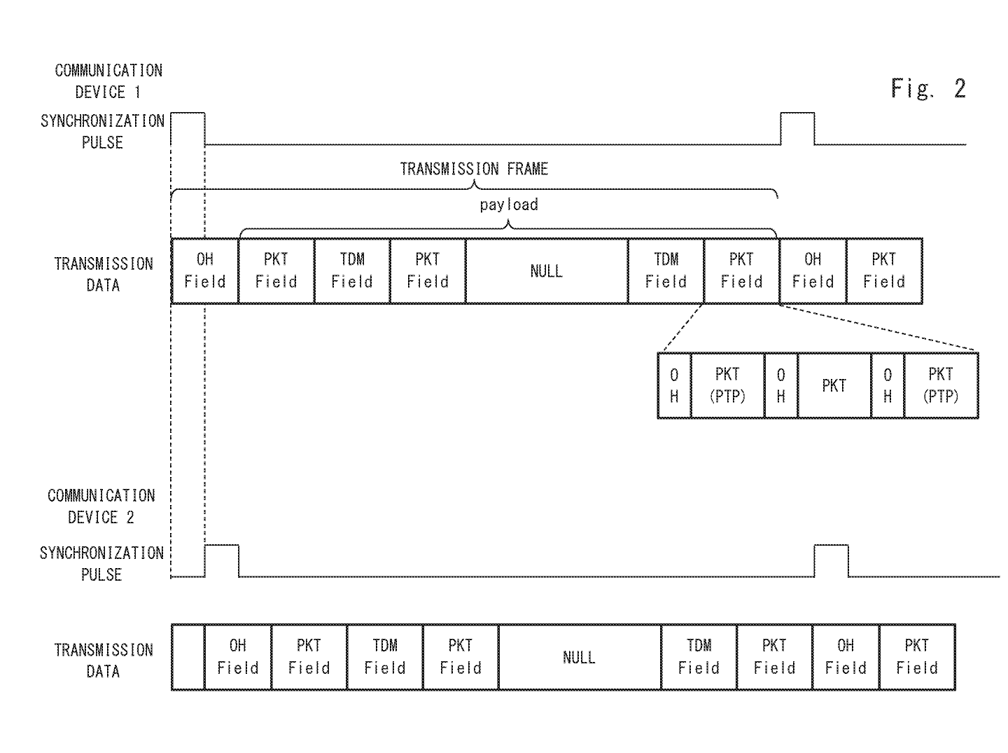

The counter 11 adjusts the count value at a predetermined timing based on a synchronization pulse (described later). Each of the communication devices (the communication device 1 and the communication device 2) detects an overhead of a transmission frame to be described later, and detects a pulse (which is hereinafter referred to as a synchronization pulse) at the timing of detecting the overhead. The concept of detecting the synchronization pulse will be described with reference to FIG. 2.

FIG. 2 is a diagram showing the concept of frame synchronization. Transmission frames are periodically transmitted between the communication devices and received thereby. As illustrated in the figure, each transmission frame is composed of an overhead field (OH field) and a payload, and a plurality of packets (for example, PTP packets) are transmitted in such a manner that the packets are multiplexed into packet fields (PKT fields) within the payload. Each packet is composed of an overhead (OH) and a payload. The overhead refers to various meta-information. Even when there is no data to be transmitted, the communication device 1 and the communication device 2 periodically transmit the transmission frames. When there is no data to be transmitted, part of the payload of each transmission frame to be transmitted is set to NULL.

The communication device 1 and the communication device 2 each include a processing unit (not shown) that detects the synchronization pulse which becomes a high level when the overhead of each transmission frame is detected. Accordingly, the synchronization pulse periodically becomes a high level as shown in FIG. 2.

The counter 11 resets the count value to “0” at the time when the synchronization pulse is input Z (Z is an integer equal to or greater than 1) times. This reset interval is set to be longer than a transmission holding time so as to prevent the counter from being reset during the transmission. Similarly, the counter 25 resets the count value to “0” at the time when the synchronization pulse is input Z times. In this manner, the counters are reset every time the synchronization pulse is input the same number of times, thereby establishing the synchronization between the counter 11 and the counter 25. A communication delay between the communication device 1 and the communication device 2 is adjusted as a fixed delay as described later.

The method of establishing the synchronization between the counter 11 of the communication device 1 and the counter 25 of the communication device 2 is not limited to the above one. For example, when the communication devices transmit and receive a TDM (Time Division Multiplex) signal, the synchronization between the counters may be established in such a manner that the transmission device (communication device 1) embeds synchronization information into the TDM signal to be transmitted and the reception device (communication device 2) adjusts the counter using the embedded synchronization information. However, the synchronization using the timing of detecting the overhead (synchronization using the synchronization pulse) as described above has an advantage in that there is no need for processing such as modification of the overhead.

Refer to FIG. 1 again. The counter 11 monitors the input of the PTP packet which is a packet for time synchronization. The counter 11 notifies the subtraction unit 12 of the count value before the PTP packet is input to the processing unit 13. The notified count value is used for subtraction processing by the subtraction unit 12.

When the packet is a PTP packet (time synchronization packet), the above-mentioned correction field (which is represented by “CF” in the figure) is included at a predetermined position within the overhead. The subtraction unit 12 reads out a value of the correction field from the overhead of the input PTP packet, and modifies the correction field with the value calculated by the following Formula (1).

(A configuration value set for the correction field by the subtraction unit 12)=(a value of the correction field before modification by the subtraction unit 12)−(a count value of the counter 11) Formula (1)

The subtraction unit 12 sets the value obtained by the subtraction in the correction field. For example, in the case of FIG. 1, when the count value detected by the counter 11 is “2” and the value of the correction field of the PTP packet input to the subtraction unit 12 is “X”, the subtraction unit 12 sets “X−2” in the correction field of the PTP packet, and inputs the configured PTP packet to the processing unit 13.

The processing unit 13 performs processing (for example, modification) on each PTP packet. The processing unit 14 performs processing in the same manner as in the processing unit 13. The time for processing each PTP packet by the processing unit 13 varies depending on configuration values for the payload and overhead of the PTP packet. In other words, the processing delay time of the processing unit 13 varies. Similarly, the processing delay time of the processing unit 14 varies. While FIG. 1 illustrates two processing units in the communication device 1, the number of processing units is not limited to two. For example, three or more processing units may be provided. In addition, a processing delay time may occur in the BB/RF conversion unit 15 and the RF/BB conversion unit 21. However, also in this case, the communication system 1 can accurately modify the correction field due to the operations of the subtraction unit 12 and the modification unit 24, regardless of the variation in the processing delay time.

The BB/RF conversion unit 15 transmits, to the communication device 2, the PTP packet on which processing of modification from a BB signal to an RF signal has been performed. The BB/RF conversion unit 15 performs not only modification processing, but also any processing associated with the transmission and reception of transmission frames.

Next, operations of each processing unit in the communication device 2 will be described. The RF/BB conversion unit 21 receives the PTP packet, performs demodulation processing, and supplies the processing unit 22 with the PTP packet on which the demodulation processing has been performed. Further, the RF/BB conversion unit 21 performs any communication processing with the BB/RF conversion unit 15.

The processing unit 22 performs processing (for example, modification) on the PTP packet according to the payload and overhead of each PTP packet. The processing unit 23 performs processing in the same manner as in the processing unit 22. The time for processing each PTP packet by the processing unit 22 varies depending on configuration values for the payload and overhead of the PTP packet. In other words, the processing delay time of the processing unit 22 varies. Similarly, the processing delay time of the processing unit 23 varies. While FIG. 1 illustrates two processing units in the communication device 2, the number of processing units is not limited to two. For example, three or more processing units may be provided.

The communication device 2 detects a synchronization pulse in the same manner as in the communication device 1. This synchronization pulse is used to synchronize the counters of the communication devices 1 and 2 as described above. The function of detecting a synchronization pulse is one of the functions of a general communication device that performs frame synchronization. The detected synchronization pulse is input to the counter 25.

The counter 25 adjusts the count value based on the input synchronization pulse. This adjustment is performed at the same timing as the adjustment by the counter 11. This allows the counter 25 and the counter 11 to be synchronized. The counter 25 notifies the modification unit 24 of the count value obtained when the PTP packet is output from the processing unit 23.

The modification unit 24 reads out a value of the correction field from the overhead of the PTP packet. The modification unit 24 sets, in the correction field, a value obtained by adding the count value of the counter 25 and a fixed delay value of a wireless transmission delay to the read value of the correction field (Formula (2)).

(A configuration value set for the correction field by the modification unit 24)=(a correction field value obtained prior to configuration by the modification unit 24)+(a count value of counter 25)+(a fixed delay value) Formula (2)

The term “fixed delay value” of the wireless transmission delay refers to a value indicating a gap between synchronization pulse detection timings of the communication devices. As shown in FIG. 2, there is a gap between the synchronization pulse detection timings. This gap is a fixed time difference that occurs depending on the environment between the communication devices and can be calculated in advance. The adjustment using this fixed delay value enables the establishment of accurate synchronization between the counter 11 and the counter 25.

In the example of FIG. 1, the modification unit 24 sets, in the correction field, “X+6(X−2+7+1)”, which is a value obtained by adding the count value “7” and the fixed delay value “1” of the wireless transmission delay, to the value “X−2” of the correction field that is transmitted from the communication device 1.

The modification unit 24 transmits the PTP packet, which is obtained after the correction field is configured, to another communication device or the like. When the above-mentioned fixed delay value is negligibly small, the modification unit 24 may modify the correction field using only the count value.

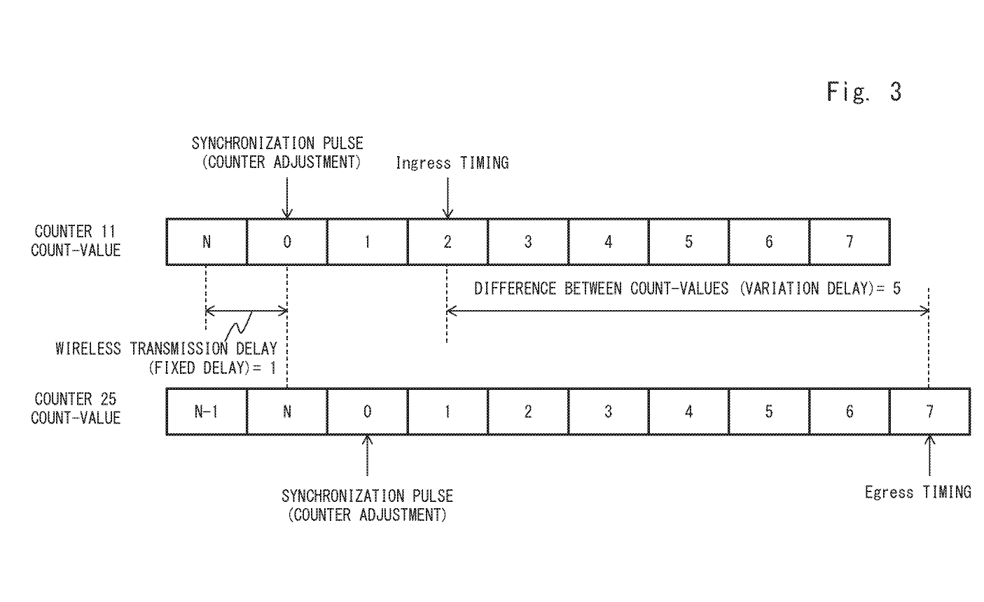

Referring next to FIG. 3, the operation of the communication system according to this exemplary embodiment will be described again. FIG. 3 is a conceptual diagram showing values set for the correction field and a relationship between the count values of the counters 11 and 25.

The counter 11 resets the count value to “0” when the synchronization pulse is detected Z times. Similarly, the counter 25 resets the count value to “0” when the synchronization pulse is detected Z times. Thus, when the fixed delay is not taken into account, the counter 11 and the counter 25 are reset simultaneously.

The counter 11 detects, as an Ingress timing, a timing before the processing of the processing unit 13 starts. The subtraction unit 12 subtracts the detected count value “2” from the correction field. The counter 25 detects, as an Egress timing, a timing when the processing of the processing unit 23 is completed. The counter 25 notifies the modification unit 24 of the detected count value “7”. The modification unit 24 sets a value obtained by adding the count value “7” (Egress timing) and the fixed delay value “1” to the value of the correction field.

Next, advantageous effects of the communication system according to this exemplary embodiment will be described. As described above, the communication device 1 (transmission device) subtracts, from the correction field, a count value indicating a timing before a varying delay occurs. The communication device 2 (reception device) adds, to the correction field, a count value indicating a timing after a varying delay occurs. In this case, since the counter 11 of the communication device 1 is synchronized with the counter 25 of the communication device 2, the value corresponding to the varying delay in each of the communication device 1 and the communication device 2 is added to the correction field. As shown in FIG. 1, the communication device 1 and the communication device 2 can modify the correction field by using only simple components such as the counters (11 and 25). In other words, the correction field can be configured while the size of the circuit configuration is kept small.

Further, the communication system according to this exemplary embodiment modifies the correction field only twice, i.e., before and after the varying delay occurs, instead of modifying the correction field every time the processing of the processing units (13, 14, 22, and 23) in which the varying delay occurs is completed. Thus, since the correction field is modified only a minimum number of times, deterioration in the accuracy of the correction field due to the modification can be avoided.

Furthermore, the communication system according to this exemplary embodiment modifies the correction field in consideration of the fixed delay that occurs between the communication systems. This makes it possible to configure the correction field with higher accuracy.

Since the subtraction unit 12 performs the subtraction directly from the correction field, the above-mentioned processing can be performed without the need to assign the count value to the overhead or the like. In other words, the communication system 100 can modify the correction field without multiplexing the data on the count value into the overhead. Since the communication device 1 does not multiplex the data into the overhead, the communication system 100 can perform the processing without slowing down the transmission speed.

### Second Exemplary Embodiment

A communication system according to a second exemplary embodiment is characterized by configuring the correction field accurately even when the counters are reset during the transmission of data between communication devices. Differences between the communication system according to this exemplary embodiment and the communication system according to the first exemplary embodiment will be described below.

The configurations of the communication device 1 and the communication device 2 according to this exemplary embodiment are similar to those of the first exemplary embodiment. In the first exemplary embodiment, a sufficiently large value is set as the maximum count value of the counter 11. In a similar manner, a sufficiently large value is set as the maximum count value of the counter 11 according to this exemplary embodiment. Also, a sufficiently large value is set as the maximum count value of the counter 25. The subtraction unit 12 modifies a flag in a reserve area of a PTP packet. This flag will be described later.

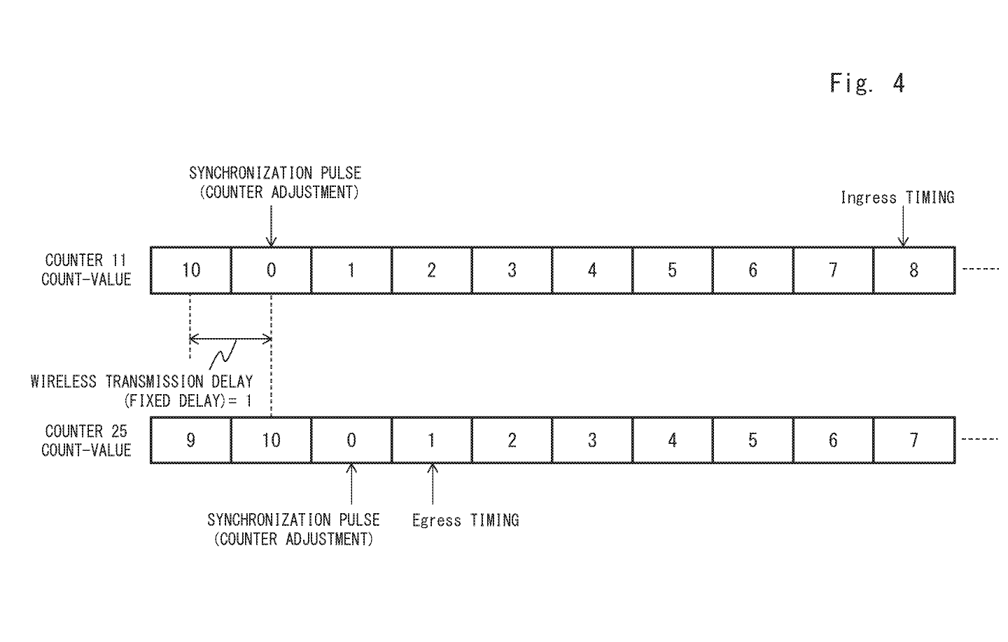

First, a case where a problem occurs in the configuration of the first exemplary embodiment will be described with reference to FIG. 4. In the following description, assume that the maximum count value of each of the counter 11 and the counter 25 is 10. Also assume that the counter 11 has detected a count value “8” as the Ingress timing of a PTP packet (a timing before the PTP packet is input to the processing unit 13). In this case, when the synchronization pulse is detected a predetermined number of times, i.e., Z times, the counter 11 and the counter 25 are reset to “0”. After that, the counter 25 detects a count value “1” as the Egress timing when the processing of the processing unit 22 and the processing unit 23 is completed. In this case, after the modification of the modification unit 24, the correction field indicates “X (the value input from the communication device 1)+1 (the count value of the counter 25)−8 (the count value of the counter 11)+1 (fixed delay)”. Thus, the value of the correction field is smaller than the value input from the communication device 1. In other words, the correction field is configured with a smaller value even though a delay occurs in the processing units (13, 14, 22, and 23). That is, a problem that an accurate value cannot be set in the correction field may occur.

Next, a solution to the above-mentioned problem by the communication system 100 according to this exemplary embodiment will be described. The communication device 1 according to this exemplary embodiment sets a flag in the reserve area of the PTP packet. This flag is a flag indicating whether the count value (Ingress timing) detected by the counter 11 for the PTP packet is greater than (the maximum count value)×(½). When “1” is set to the flag, the flag indicates that the count value is greater than (the maximum count value)×(½). On the other hand, when “0” is set to the flag, the flag indicates that the count value is not greater than (the maximum count value)×(½). Note that this flag can be multiplexed into the overhead of the PTP packet.

The subtraction unit 12 performs the subtraction processing from the correction field as described above, and sets a flag. The modification unit 24 obtains a value of the flag from the overhead of the PTP packet. The value of the flag obtained by the modification unit 24 is hereinafter referred to as an Ingress timing flag. The modification unit 24 makes a calculation as to whether the count value (Egress timing), which has been sent from the counter 25 and converted to a flag, indicates “0” or “1”. The converted value is hereinafter referred to as an Egress timing flag.

In the following case, the modification unit 24 performs processing in the same manner as in the first exemplary embodiment.

Ingress timing flag=0, Egress timing flag=0

Ingress timing flag=0, Egress timing flag=1

Ingress timing flag=1, Egress timing flag=1

In the following case, the modification unit 24 calculates a modification value for the correction field by the following Formula (3). For reference, the configuration value set by the subtraction unit 12 is also shown in Formula (1).

Ingress timing flag=1, Egress timing flag=0

(A configuration value set for the correction field by the subtraction unit 12)=(a correction field value obtained prior to modification by the subtraction unit 12)−(a count value of the counter 11) Formula (1)

(A configuration value set for the correction field by the modification unit 24)=(a correction field value)+(a count value)+(a fixed delay value)+(a maximum count value) Formula (3)

Thus, in the case shown in FIG. 4, the correction field is modified in the following manner. Assume that the correction field value obtained prior to modification by the subtraction unit 12 is X.

The subtraction unit 12 sets “X−8” in the correction field by using the count value “8” of the counter 11. The modification unit 24 sets “X+4(X−8+1+1+10)” in the correction field by using the count value “1” of the counter 25, the fixed delay value “1”, and the maximum count value “10”. The other processing of this exemplary embodiment is the same as that of the first exemplary embodiment, and thus the detailed description thereof is omitted.

Next, advantageous effects of the communication system 100 according to this exemplary embodiment will be described. As described above, the communication device 1 and the communication device 2 assign a flag for determining whether or not the counters have been reset. Further, the communication devices 1 and 2 use the flag to determine whether the counters have been reset during the processing of the processing units (13, 14, 22, and 23) or during transmission of packets, and configure the correction field according to the determination. Thus, even if the counters have been reset, an accurate value can be set in the correction field.

In the above description, a sufficiently large value is used as the maximum count value of each of the counter 11 and the counter 25. Accordingly, there is no need to use (a maximum counter length)×(½) as a reference. The flag may be assigned based on a reference value for determining whether or not the counters have been reset.

### Third Exemplary Embodiment

A communication system according to a third exemplary embodiment is characterized by it being able to reduce a gap between the counters and to configure the correction field with higher accuracy. Differences between the communication system according to this exemplary embodiment and the communication system according to the first exemplary embodiment will be described below.

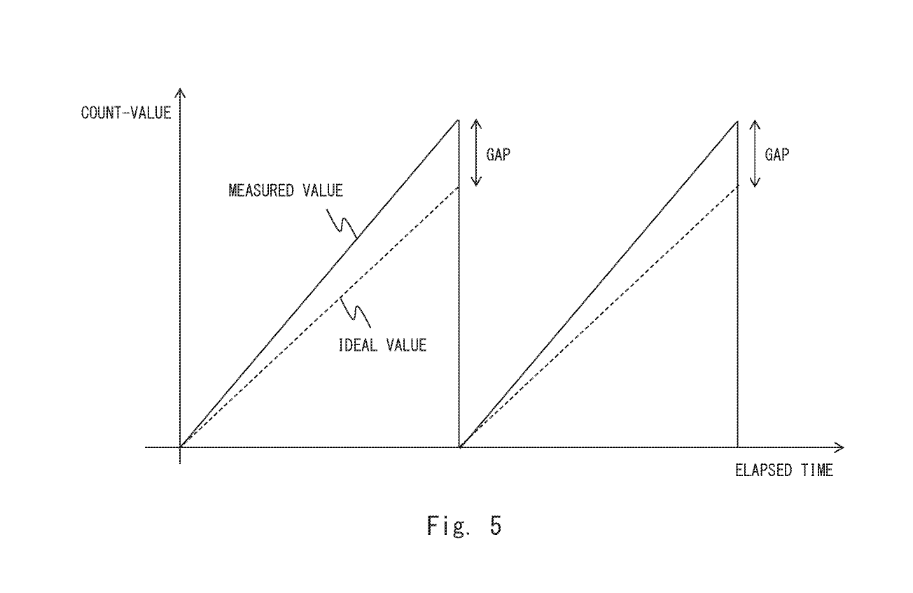

The configuration of the communication system 100 according to this exemplary embodiment is similar to the configuration shown in FIG. 1. Accordingly, the respective detailed descriptions of processing units are omitted. First, the adjustment of the count value of the counter 11 (or the counter 25) according to the first exemplary embodiment will be described with reference to FIG. 5.

In general, the counter 11 performs count processing based on an oscillation signal of an internal oscillating circuit or the like. However, a gap may occur between a count value and an ideal value depending on the operation of the oscillating circuit. For example, as shown in FIG. 5, as the count value increases, the gap between the ideal value and the measured count value increases. The counter 11 (25) according to the first exemplary embodiment adjusts the count value (i.e., resets the count value to “0”) at a timing when the synchronization pulse is detected a plurality of times. Accordingly, there is a possibility that a predetermined gap may occur as shown in FIG. 5.

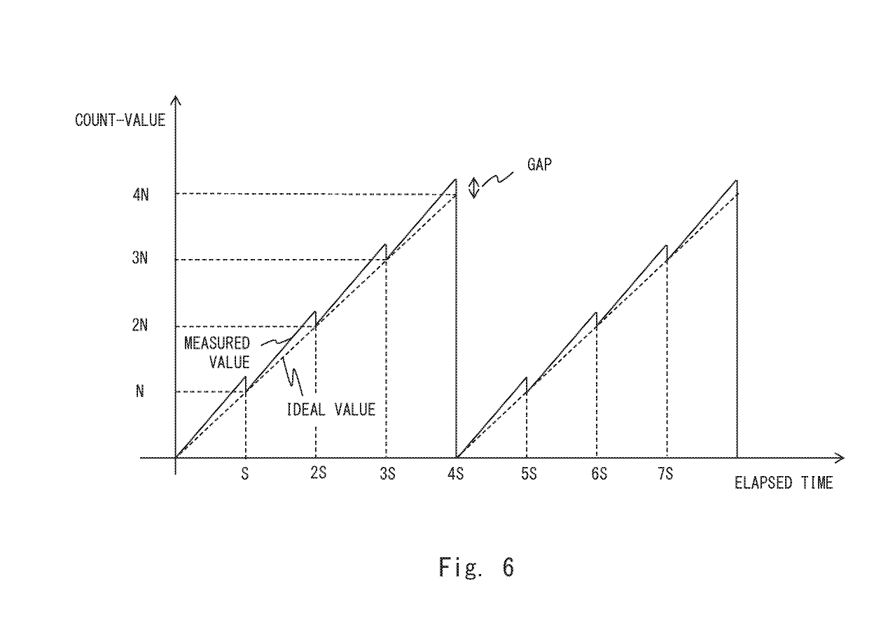

The counter 11 and the counter 25 according to this exemplary embodiment adjust the count values every time the synchronization pulse is detected. The concept of this operation will be described with reference to FIG. 6. In the following description, assume that when there is no error in the accuracy of the oscillating circuit or the like that operates the counter 11, the synchronization pulse is detected every S seconds (that is, S seconds correspond to an ideal detection period for detecting the overhead of the transmission frame) and the operation frequency of the counter 11 is represented by f.

In this case, the counter 11 calculates a count value N by multiplying the operating frequency (f) by a synchronization pulse detection period (S seconds). The counter 11 adjusts the count value using the count value N every S seconds. Specifically, the counter 11 adjusts the count value to N after a lapse of S seconds from the start of counting, adjusts the count value to 2N after a lapse of 2S seconds therefrom, and adjusts the count value to 3N after a lapse of 3S seconds therefrom. As illustrated in the figure, the counter 11 adjusts the count value so that the count value is reset to at a timing when the count value approaches the maximum count value (about 4N in the example of FIG. 6). In this manner, the count value is adjusted every S seconds as shown in FIG. 6. The count value of the counter 25 is adjusted in the same manner.

As is apparent from a comparison between FIGS. 5 and 6, each of the counter 11 and the counter 25 according to this exemplary embodiment can reduce the gap between the measured value and the ideal value for adjusting the count value for each synchronization pulse, and can improve the accuracy of the count value. The improvement in the accuracy of the count value leads to an improvement in the accuracy of modifying the correction field as compared to other exemplary embodiments.

It is most desirable that both the counter 11 and the counter 25 adjust the count value as shown in FIG. 6. However, it is not necessary that both of the counters adjust the count value as shown in FIG. 6. In other words, even when only one of the counters adjusts the count value as shown in FIG. 6, the accuracy of the count value can be improved in comparison to the first exemplary embodiment.

### Fourth Exemplary Embodiment

A communication system according to this exemplary embodiment is characterized by configuring the correction field after detecting that there is no difference between the configurations of the communication devices. Differences between the communication system according to this exemplary embodiment and the communication system according to the first exemplary embodiment will be described below.

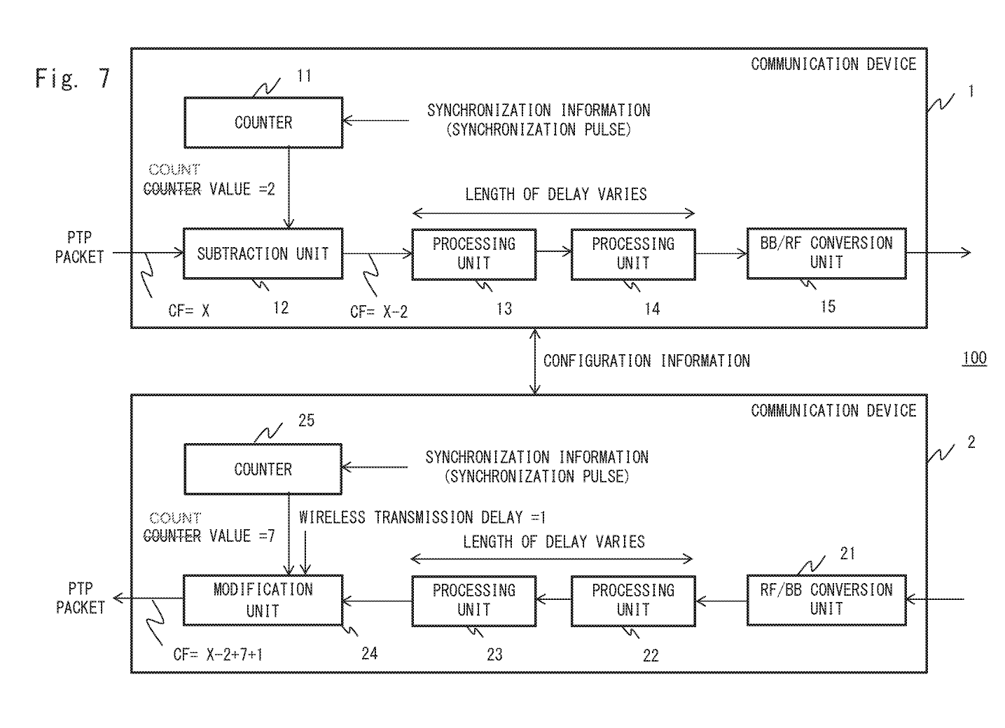

FIG. 7 shows the configuration of the communication system 100 according to this exemplary embodiment. The configuration of the communication system 100 according to this exemplary embodiment is substantially the same as the configuration shown in FIG. 1. However, the communication system 100 according to this exemplary embodiment transmits configuration information between the communication devices. The term “configuration information” refers to information indicating a configuration in which each communication device operates. The configuration information includes information indicating whether the correction field has been modified or not. Note that the communication device 1 may transmit the configuration information to the communication device 2, or the communication device 2 may transmit the configuration information to the communication device 1. The configuration information may be transmitted at any timing.

A case where the communication device 1 has transmitted, to the communication device 2, the configuration information including information indicating that “the correction field has not been modified” will be described. In this case, if the communication device 2 operates in a configuration in which “the correction field is to be modified”, the communication device 2 immediately changes the configuration to a configuration in which the correction field is not to be modified. This prevents the operation from being unstable due to the modification of the correction field in only one of the communication devices. Since the configuration of one of the communication devices may be set to be the same as the configuration of the other one of the communication devices, both of the communication devices may operate in the configuration in which the correction field is to be modified if there is a difference between the configurations of the communication devices.

The present invention has been described above with reference to exemplary embodiments. However, the present invention is not limited to the configurations of the above exemplary embodiments. The present invention includes various changes, modifications, or combinations which can be made to the embodiments by those skilled in the art, without departing from the scope of the claims of the present application, as a matter of course.

This application is based upon and claims the benefit of priority from Japanese patent application No. 2013-127406, filed on Jun. 18, 2013, the disclosure of which is incorporated herein in its entirety by reference.

### INDUSTRIAL APPLICABILITY

The present invention is applicable to systems that require time synchronization.

### REFERENCE SIGNS LIST

1 COMMUNICATION DEVICE
11 COUNTER
12 SUBTRACTION UNIT
13 PROCESSING UNIT
14 PROCESSING UNIT
15 BB/RF CONVERSION UNIT
2 COMMUNICATION DEVICE
21 RF/BB CONVERSION UNIT
22 PROCESSING UNIT
23 PROCESSING UNIT
24 MODIFICATION UNIT
25 COUNTER
31 CORRECTION FIELD
100 COMMUNICATION SYSTEM

1. A communication system comprising:
a transmission device that transmits a time synchronization packet for time synchronization; and
a reception device that receives the time synchronization packet, wherein
the transmission device includes:
a first counter that is synchronized with a second counter within the reception device, and measures, as a first count value, a timing before the time synchronization packet is input to a processing unit that performs processing on the time synchronization packet; and
a subtraction unit that modifies a value of a delay amount field within the time synchronization packet with a value obtained by subtracting the first count value, the value of the delay amount field indicating a total amount of delay in a relay device, and
the reception device includes:
the second counter that measures, as a second count value, a timing when processing by a processing unit that performs processing on the time synchronization packet is completed; and
a modification unit that modifies the delay amount field based on the second count value and the value of the delay amount field.

2. The communication system according to claim 1, wherein the modification unit extracts the value of the delay amount field, and modifies the delay amount field with a value obtained by adding, to the extracted value, the second count value and a fixed delay value generated in communication between the transmission device and the reception device.

3. The communication system according to claim 1, wherein
the first counter and the second counter are counters that handle a maximum count value which is sufficiently larger than a possible delay in processing in each of the reception device and the transmission device,
the subtraction unit assigns a flag to the time synchronization packet, the flag indicating a magnitude of the first count value, and
the modification unit modifies the delay amount field according to a relationship between the flag and the second count value.

4. The communication system according to claim 1, wherein
the reception device and the transmission device periodically transmit and receive a transmission frame which may include the time synchronization packet, and
the transmission device adjusts a count value of the first counter based on a timing of detecting an overhead of the transmission frame, and the reception device synchronizes the counters by adjusting the second count value based on the timing of detecting the overhead of the transmission frame.

5. The communication system according to claim 4, wherein the transmission device adjusts the count value of the first counter at each timing of detecting the overhead of the transmission frame by using a multiplication value N obtained by multiplying an operating frequency f of the first counter by an ideal detection period S for detecting the overhead of the transmission frame.

6. The communication system according to claim 4, wherein the reception device adjusts a count value of the second counter at each timing of detecting the overhead of the transmission frame by using a multiplication value N obtained by multiplying an operating frequency f of the second counter by an ideal detection period S for detecting the overhead of the transmission frame.

7. The communication system according to claim 1, wherein
one of the reception device and the transmission device transmits, to the other one of the reception device and the transmission device, configuration information indicating whether the delay amount field has been modified or not, and
when there is a difference between a configuration for modifying the delay amount field in the reception device and that in the transmission device, the former configuration is set to be the same as the latter.

8. The communication system according to claim 1, wherein a maximum count value of the first counter is equal to a maximum count value of the second counter.

9. A control method for a communication system, the communication system comprising: a transmission device that transmits a time synchronization packet for time synchronization; and a reception device that receives the time synchronization packet,
the control method comprising:
a first counting step of establishing, by the transmission device, synchronization with a counter within the reception device and measuring, as a first count value, a timing before the time synchronization packet is input to a processing unit that performs processing on the time synchronization packet;
a subtraction step of modifying, by the transmission device, a value of a delay amount field within the time synchronization packet with a value obtained by subtracting the first count value, the value of the delay amount field indicating a total amount of delay in a relay device;
a second counting step of measuring, by the reception device, a timing when processing by a processing unit that performs processing on the time synchronization packet is completed, as a second count value; and
a modification step of modifying, by the reception device, the delay amount field based on the second count value and the value of the delay amount field.

10. The control method for a communication system according to claim 9, wherein in the modification step, the value of the delay amount field is extracted and the delay amount field is modified using a value obtained by adding, to the extracted value, the second count value and a fixed delay value generated in communication between the transmission device and the reception device.

11. The control method for a communication system according to claim 9, wherein
a maximum count value in the first counting step and a maximum count value in the second counting step are sufficiently larger than a possible delay in processing in each of the reception device and the transmission device,
in the subtraction step, a flag indicating a magnitude of the first count value is assigned to the time synchronization packet, and
in the modification step, the delay amount field is modified according to a relationship between the flag and the second count value.

12. The communication method for a communication system according to claim 9, wherein
the reception device and the transmission device periodically transmit and receive a transmission frame which may include the time synchronization packet, and
the transmission device adjusts a count value of the first counter based on a timing of detecting an overhead of the transmission frame, and the reception device synchronizes the counters by adjusting the second count value based on the timing of detecting the overhead of the transmission frame.

13. The control method for a communication system according to claim 12, wherein the transmission device adjusts the count value of the first counter at each timing of detecting the overhead of the transmission frame by using a multiplication value N obtained by multiplying an operating frequency f of the first counter by an ideal detection period S for detecting the overhead of the transmission frame.

14. The control method for a communication system according to claim 12, wherein the reception device adjusts a count value of the second counter at each timing of detecting the overhead of the transmission frame by using a multiplication value N obtained by multiplying an operating frequency f of the second counter by an ideal detection period S for detecting the overhead of the transmission frame.

15. The control method for a communication system according to claim 9, wherein
one of the reception device and the transmission device transmits, to the other one of the reception device and the transmission device, configuration information indicating whether the delay amount field has been modified or not, and
when there is a difference between a configuration for modifying the delay amount field in the reception device and that in the transmission device, the former configuration is set to be the same as the latter.

16. A transmission device that transmits a time synchronization packet for time synchronization, the transmission device comprising:
a first counter that measures, as a first count value, a timing before the time synchronization packet is input to a processing unit that performs processing on the time synchronization packet; and
a subtraction unit that modifies a value of a delay amount field within the time synchronization packet with a value obtained by subtracting the first count value, the value of the delay amount field indicating a total amount of delay in a relay device.

17. The transmission device according to claim 16, wherein
the first counter is a counter that handles a maximum count value which is sufficiently larger than a possible delay in processing in each of the transmission device and a reception device that receives the time synchronization packet, and
the subtraction unit assigns a flag to the time synchronization packet, the flag indicating a magnitude of the first count value.

18. The transmission device according to claim 16, wherein
the transmission device and a reception device that receives the time synchronization packet periodically transmit and receive a transmission frame which may include the time synchronization packet, and
the transmission device adjusts a count value of the first counter based on a timing of detecting an overhead of the transmission frame.

19. The transmission device according to claim 18, wherein the count value of the first counter is adjusted at each timing of detecting the overhead of the transmission frame by using a multiplication value N obtained by multiplying an operating frequency f of the first counter by an ideal detection period S for detecting the overhead of the transmission frame.

20. A reception device that receives a time synchronization packet for time synchronization, the reception device comprising:
a second counter that measures, as a second count value, a timing when processing by a processing unit that performs on the time synchronization packet is completed; and
a modification unit that modifies a delay amount field based on the second count value and a value of the delay amount field.

21. The reception device according to claim 20, wherein the modification unit extracts the value of the delay amount field and modifies the delay amount field by using a value obtained by adding, to the extracted value, the second count value and a fixed delay value generated in communication between the transmission device and the reception device.

22. The reception device according to claim 20, wherein
the reception device and a transmission device that transmits the time synchronization packet periodically transmit and receive a transmission frame which may include the time synchronization packet, and
the reception device synchronizes the second counter with a counter within the transmission device by adjusting the second count value based on a timing of detecting an overhead of the transmission frame.

23. The reception device according to claim 22, wherein a count value of the second counter is adjusted at each timing of detecting the overhead of the transmission frame by using a multiplication value N obtained by multiplying an operating frequency f of the second counter by an ideal detection period S for detecting the overhead of the transmission frame.
